(19) United States
(12) Patent Application Publication
(10) Pub. No.: US 2013/0331041 A1
(43) Pub. Date: Dec. 12, 2013

(54) ELECTRONIC APPARATUS AND CONTROL METHOD FOR ELECTRONIC APPARATUS

(71) Applicants: Masao Teshima, Kunitachi-shi (JP); Satoshi Kawashimo, Ome-shi (JP); Satoshi Yokote, Ome-shi (JP); Hiroki Takenouchi, Akishima-shi (JP)

(72) Inventors: Masao Teshima, Kunitachi-shi (JP); Satoshi Kawashimo, Ome-shi (JP); Satoshi Yokote, Ome-shi (JP); Hiroki Takenouchi, Akishima-shi (JP)

(21) Appl. No.: 13/731,923

(22) Filed: Dec. 31, 2012

(30) Foreign Application Priority Data
Jun. 12, 2012 (JP) 2012-133288

(51) Int. Cl. H04B 1/40

(52) U.S. Cl. CPC H04B 1/40
USPC 455/73

(57) ABSTRACT

According to one embodiment, an electronic apparatus includes a first and second section and a wireless communication module. The second section includes a display unit, is coupled to the first section, and is configured to move between a first position where the second section is configured to cover an input unit and a communication area in the first section, a second position where the second section is configured to cover at least a part of the input unit and to allow the communication area to be exposed, and a third position where the second section is configured to allow the input unit and the communication area to be exposed.

### CROSS-REFERENCE TO RELATED APPLICATIONS

This application is based upon and claims the benefit of priority from Japanese Patent Application No. 2012-133288, filed Jun. 12, 2012, the entire contents of which are incorporated herein by reference.

### FIELD

Embodiments described herein relate generally to an electronic apparatus and a control method for an electronic apparatus.

### BACKGROUND

Some electronic apparatuses, e.g., portable computers, may comprise a module for wireless communication, such as a near-field communication (NFC) module. The NFC module performs wireless communication with devices, such as smartcards, cell phones, etc., and other information media.

An area above which the smartcards or other media are to be waved is provided on, for example, the bottom surface, a surface on which a display is disposed, or a palmrest of the electronic apparatus. The NFC module performs wireless communication with the media waved above the area.

Electronic apparatuses are handled in various situations. For example, they may be placed on a desk, carried from one place to another, or grasped. Depending on the mode of use of the electronic apparatuses, the wireless communication module may fail to be user-friendly.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing a portable computer according to a first embodiment;

FIG. 2 is an exemplary sectional view of the portable computer of the first embodiment taken along line F2-F2 of FIG. 1;

FIG. 3 is an exemplary perspective view of the portable computer of the first embodiment with its display unit in a second position;

FIG. 4 is an exemplary sectional view of the portable computer of the first embodiment taken along line F4-F4 of FIG. 3;

FIG. 5 is an exemplary perspective view of the portable computer of the first embodiment with the display unit in a third position;

FIG. 6 is an exemplary sectional view of the portable computer of the first embodiment taken along line F6-F6 of FIG. 5;

FIG. 7 is an exemplary perspective view of the portable computer of the first embodiment with the display unit raised in position;

FIG. 8 is an exemplary sectional view of the portable computer of the first embodiment taken along line F8-F8 of FIG. 7;

FIG. 9 is an exemplary perspective view of the portable computer of the first embodiment with the display unit in a fourth position;

FIG. 10 is an exemplary sectional view of the portable computer of the first embodiment taken along line F10-F10 of FIG. 9;

FIG. 11 is an exemplary diagram schematically showing a configuration of the portable computer of the first embodiment;

FIG. 12 is an exemplary flowchart showing an example of a control method performed when the display unit of the first embodiment moves;

FIG. 13 is an exemplary perspective view showing a portable computer according to a second embodiment;

FIG. 14 is an exemplary perspective view showing a portable computer according to a third embodiment with its display unit in a first position;

FIG. 15 is an exemplary sectional view of the portable computer of the third embodiment taken along line F15-F15 of FIG. 14;

FIG. 16 is an exemplary perspective view of the portable computer of the third embodiment with the display unit in a second position;

FIG. 17 is an exemplary perspective view of the portable computer of the third embodiment with the display unit in a third position;

FIG. 18 is an exemplary sectional view of the portable computer of the third embodiment taken along line F18-F18 of FIG. 17; and

FIG. 19 is an exemplary perspective view showing a portable computer according to a fourth embodiment.

### DETAILED DESCRIPTION

Various embodiments will be described hereinafter with reference to the accompanying drawings.

In general, according to one embodiment, an electronic apparatus includes a first section, a wireless communication module, and a second section. The first section includes a first surface which includes an input unit and a communication area. The wireless communication module in the first section is configured to perform wireless communication with the outside of the communication area. The second section includes a display unit configured to display an image, is coupled to the first section, and is configured to move between a first position where the second section is configured to cover the input unit and the communication area, a second position where the second section is configured to cover at least a part of the input unit and to allow the communication area to be exposed, and a third position where the second section is configured to allow the input unit and the communication area to be exposed.

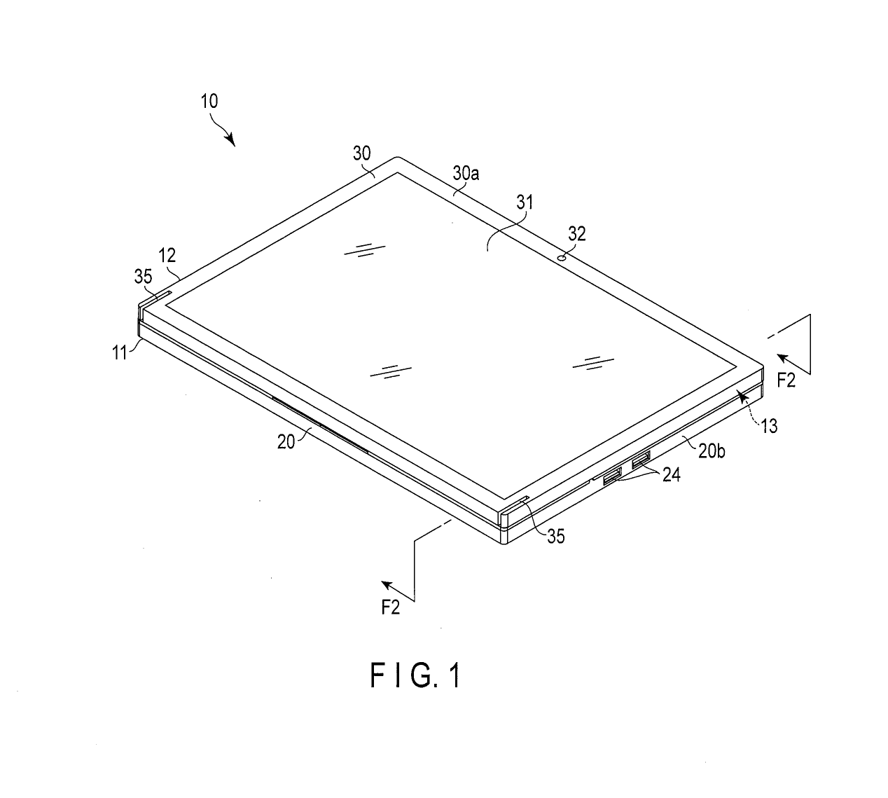

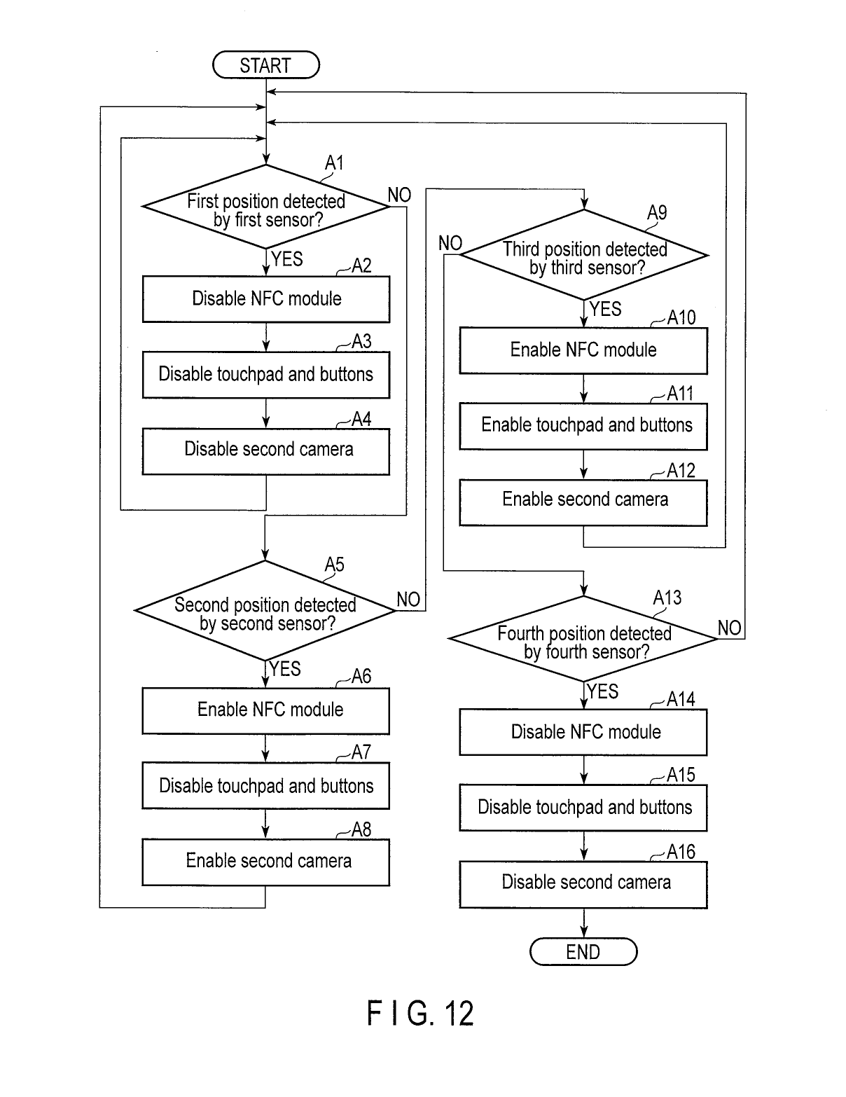

A first embodiment will now be described with reference to FIGS. 1 and 12. In this specification, the near or user side is defined as forward; the far side from the user as rearward, the user's left-hand side as leftward, the user's right-hand side as rightward, and the upper and lower sides with respect to the user as upward and downward, respectively. Further, each element that can be expressed in different ways may sometimes be represented by one or more alternative examples of expressions. However, this neither denies that an element that is not given any alternative expression can be differently expressed, nor restricts other expressions that are not exemplified.

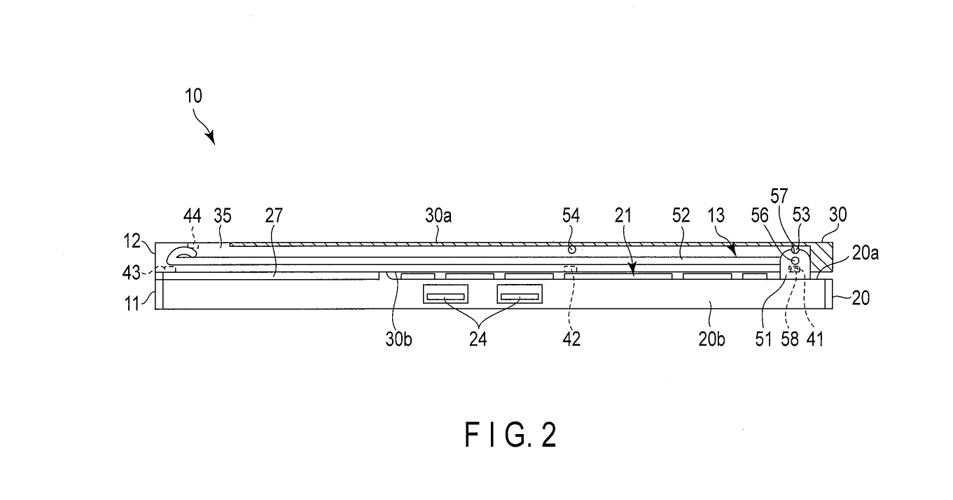

FIG. 1 is an exemplary perspective view showing a portable computer 10 according to a first embodiment. FIG. 2 is an exemplary sectional view of the portable computer 10 taken along line F2-F2 of FIG. 1. As shown in FIG. 1, the portable computer 10 is a so-called tablet computer. The electronic apparatus is not limited to the tablet computer and may be another apparatus such as a portable DVD player.

The portable computer 10 comprises a main unit 11, display unit 12, and slide hinge structures 13. The main unit 11 is an example of a first section, while the display unit 12 is an example of a second section.

The display unit 12 is coupled to the main unit 11 by the slide hinge structures 13 for movement between the first to fourth positions. In the portable computer 10 shown in FIGS. 1 and 2, the display unit 12 is located in the first position.

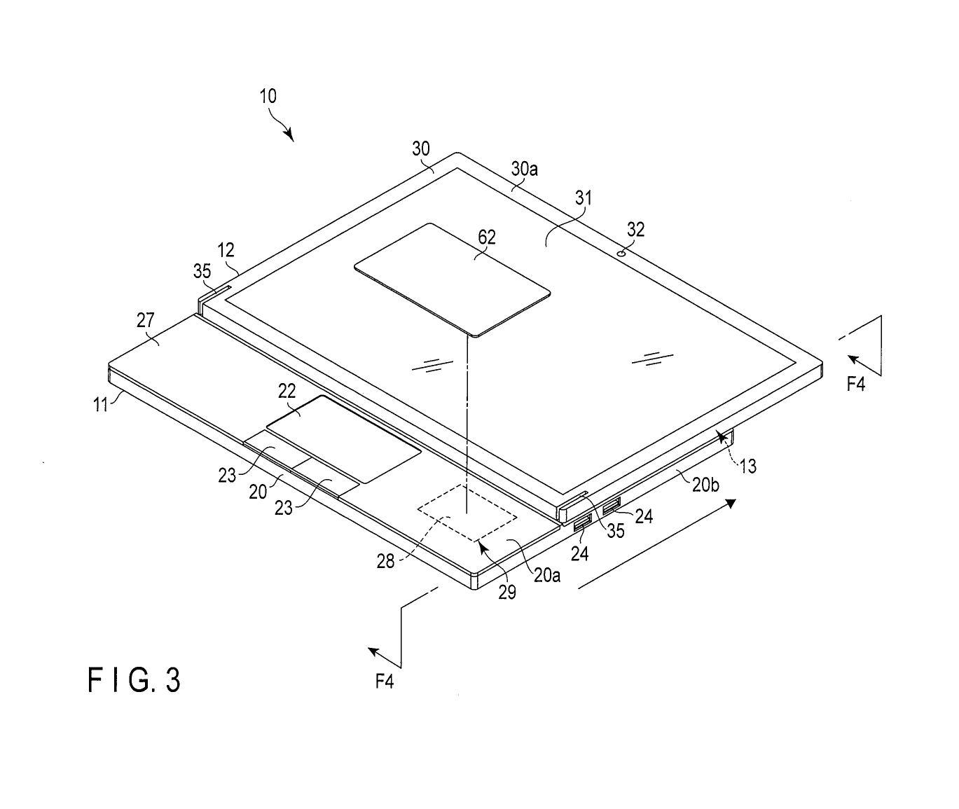

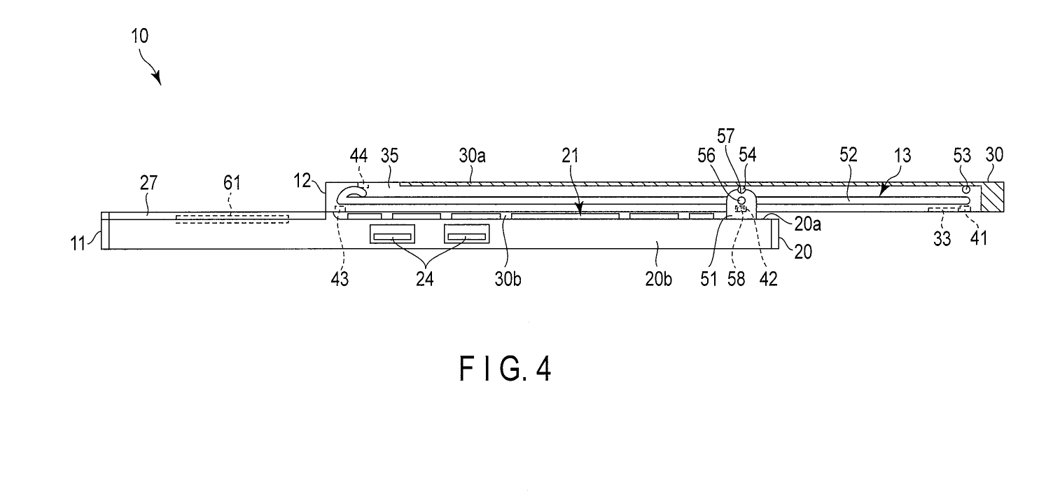

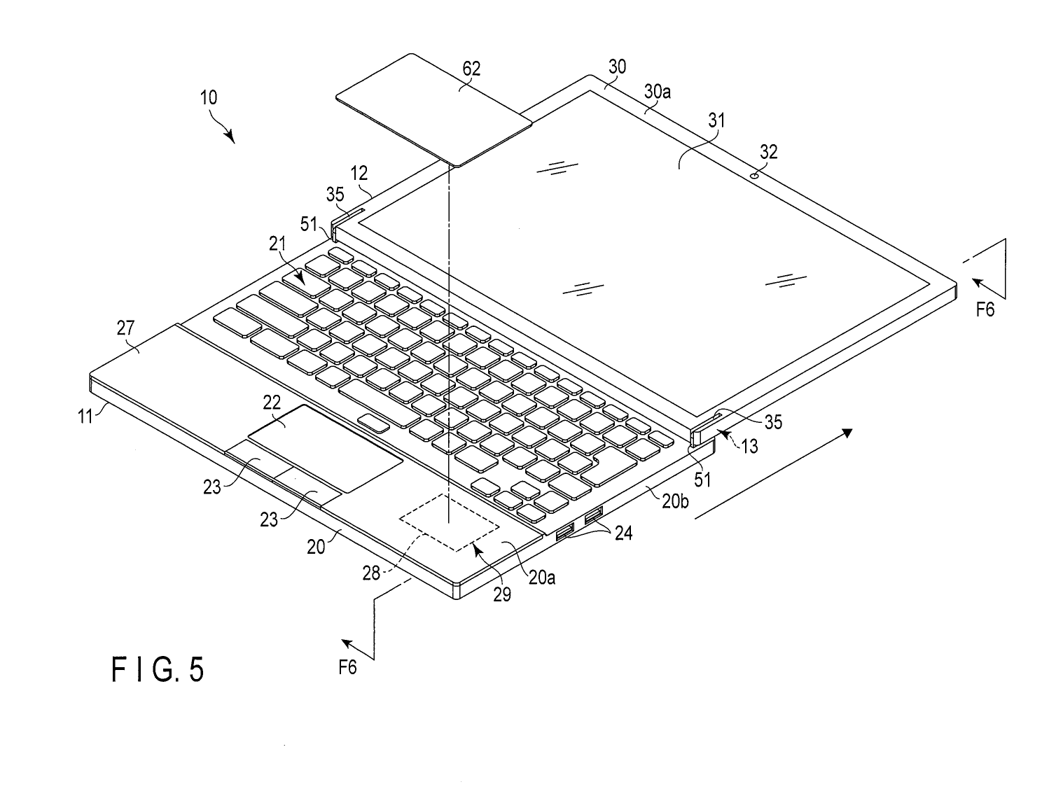

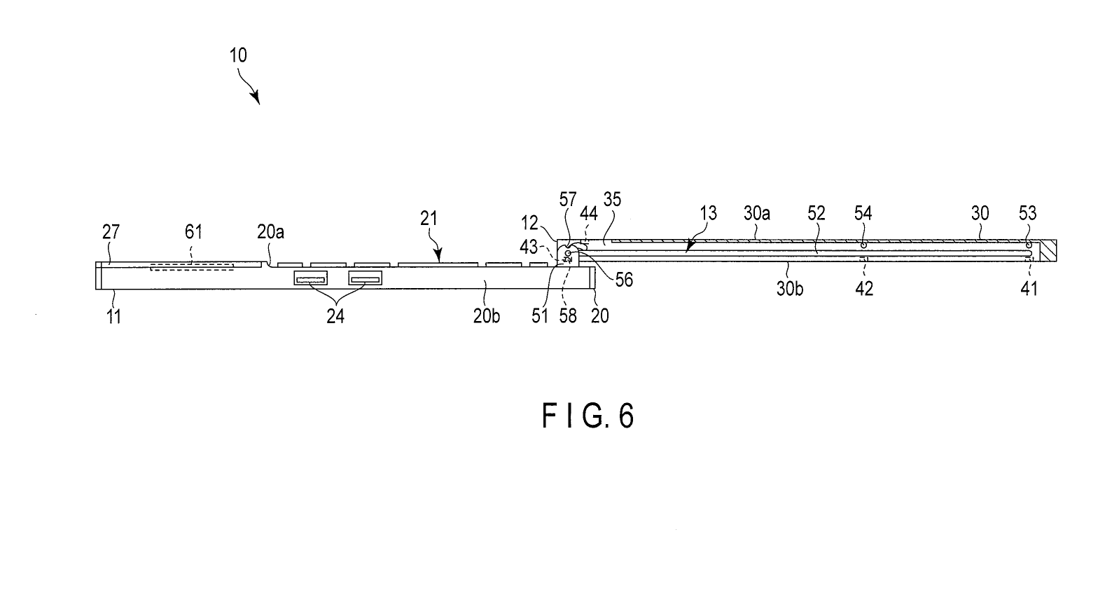

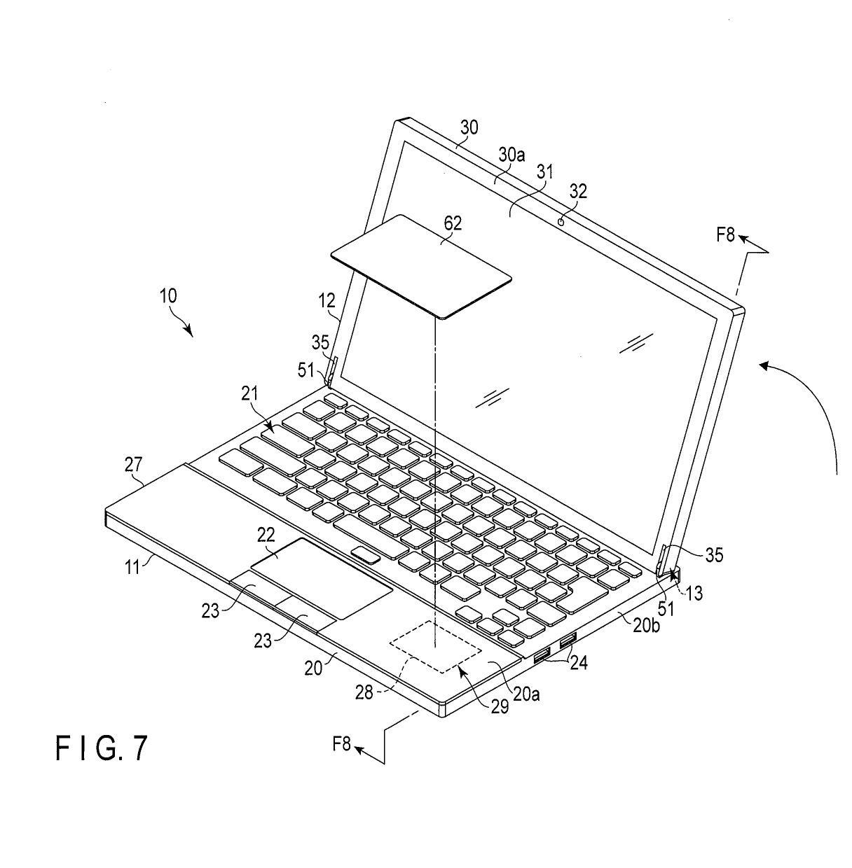

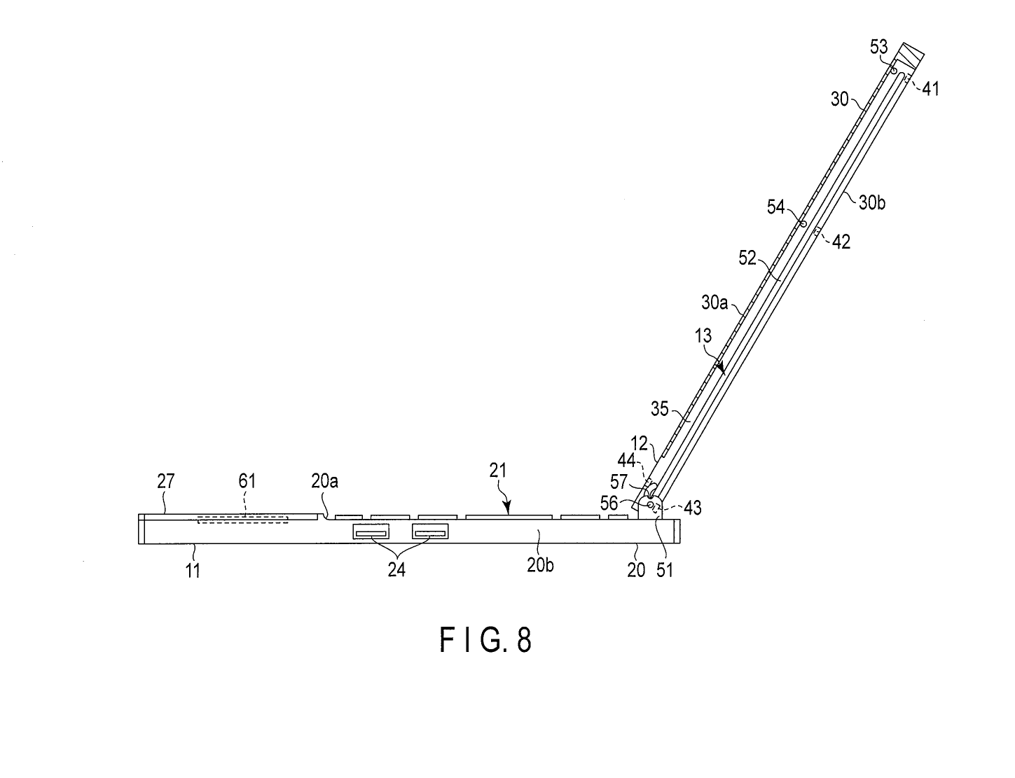

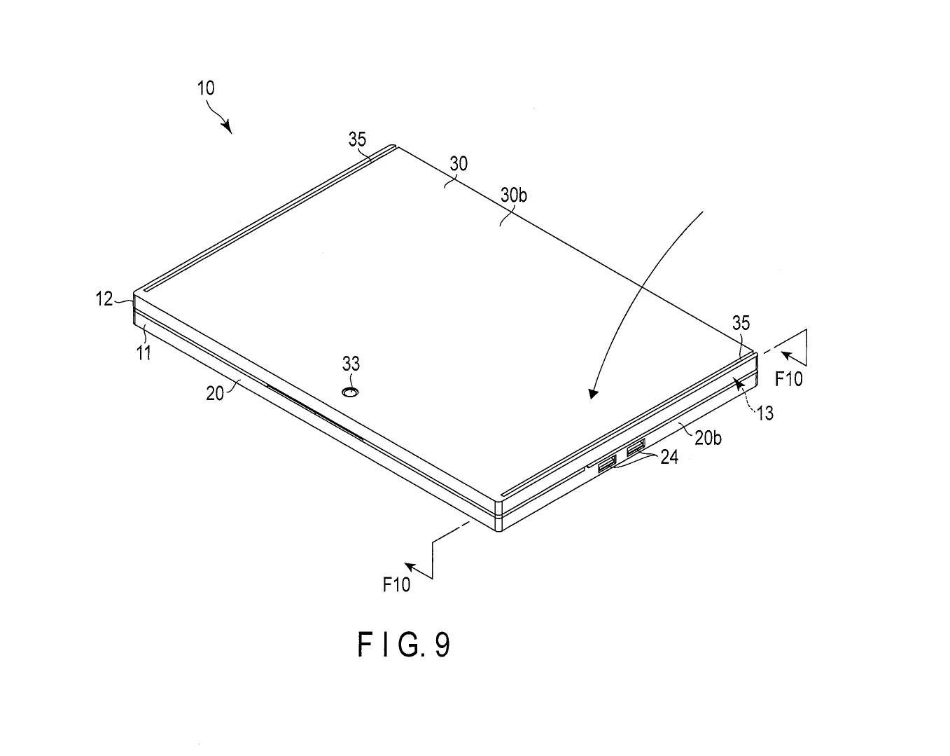

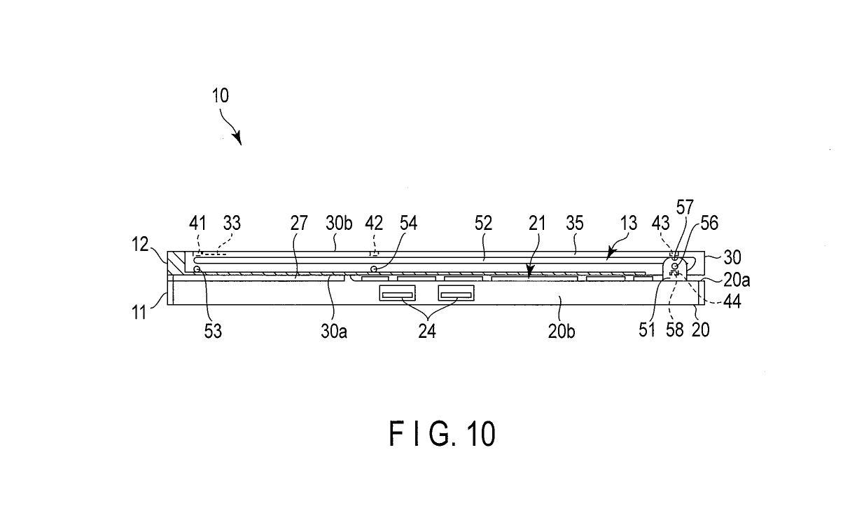

FIG. 3 is an exemplary perspective view of the portable computer 10 with the display unit 12 in the second position. FIG. 4 is an exemplary sectional view of the portable computer 10 taken along line F4-F4 of FIG. 3. FIG. 5 is an exemplary perspective view of the portable computer 10 with the display unit 12 in the third position. FIG. 6 is an exemplary sectional view of the portable computer 10 taken along line F6-F6 of FIG. 5. FIG. 7 is an exemplary perspective view of the portable computer 10 with the display unit 12 raised in position. FIG. 8 is an exemplary sectional view of the portable computer 10 taken along line F8-F8 of FIG. 7. FIG. 9 is an exemplary perspective view of the portable computer 10 with the display unit 12 in the fourth position. FIG. 10 is an exemplary sectional view of the portable computer 10 taken along line F10-F10 of FIG. 9.

The structure of the portable computer 10 will be described suitably with reference to FIGS. 1 to 10. As shown in FIG. 7, the main unit 11 comprises a rectangular first housing 20, keyboard 21, touchpad 22, a pair of click buttons 23, and connectors 24. The keyboard 21 is an example of an input unit.

The first housing 20 comprises a palmrest 27. The palmrest 27 can be alternatively expressed as, for example, a wall portion, top surface, or flat portion. The palmrest 27 forms a part of a top surface 20a of the first housing 20. The top surface 20a is an example of a first surface. While the first housing 20 is made of, for example, a metal such as a magnesium alloy, the palmrest 27 is made of a resin. The resin is an example of a nonconductor. The nonconductor is, for example, an insulator that does not intercept radio waves.

The keyboard 21 is disposed on the top surface 20a of the first housing 20 and located behind the palmrest 27. The keyboard 21 is used for various input operations such as character input.

The touchpad 22 is used for various input operations such as cursor movement. The click buttons 23 are used for various input operations such as clicking. The touchpad 22 and click buttons 23 are located on the palmrest 27, that is, in front of the keyboard 21.

The connectors 24 are disposed on a side surface 20b of the first housing 20. The connectors 24 are various connectors such as USB connectors or HDMI connectors. The first housing 20 further comprises various elements, such as a power button, earphone jack, and vent holes.

The first housing 20 of the main unit 11 accommodates various components, such as a motherboard, hard disk drive (HDD), battery, and near-field communication (NFC) module 28. The NFC module 28 is an example of a wireless communication module and can be alternatively expressed as, for example, a component, module, or communication device. Since the NFC module 28 is concealed within the first housing 20, it is indicated by a broken line in the drawings. Various electronic components, such as a central processing unit (CPU) and memory, are mounted on the motherboard.

The NFC module 28 is covered by a part of the palmrest 27. That part of the palmrest 27 which covers the NFC module 28 is defined as a communication area 29. Thus, the communication area 29 is a part of the palmrest 27 included in the top surface 20a of the first housing 20. The NFC module 28 is located, for example, below the communication area 29. The communication area 29 may be printed with a picture, embossed, or affixed with a sticker so that it can be recognized from outside the first housing 20.

The display unit 12 comprises a rectangular second housing 30, display module 31, a first camera 32, and a second camera 33. For example, the second camera 33 is shown in FIG. 9. The display module 31 is an example of a display unit and touchpanel. The second camera 33 is an example of a camera and can be alternatively expressed as, for example, a component or module.

The display module 31 is, for example, a liquid-crystal display. The display module 31 is not limited to this and may alternatively be a component, such as an organic electroluminescent display that displays various images. The display module 31 is a touchpanel, which can detect, for example, the user's fingertip and be used for various input operations.

The display module 31 is exposed through an opening in a front surface 30a of the second housing 30. The front surface 30a is an example of a second surface. In other words, the display module 31 is disposed on the front surface 30a of the second housing 30.

The first camera 32 is disposed on the front surface 30a of the second housing 30. On the other hand, the second camera 33 is disposed on a back surface 30b of the second housing 30, as shown in FIG. 9. The back surface 30b, which is located opposite the front surface 30a, is an example of a third surface. When the display unit 12 is in the first position, as shown in FIG. 2, the back surface 30b faces the top surface 20a of the first housing 20. The second camera 33 is located at the upper end portion of the second housing 30.

As shown in FIG. 8, a pair of slits 35 are provided ranging from the front surface 30a to the back surface 30b of the second housing 30. The slits 35 are located individually at the left- and right-hand end portions of the second housing 30. The slits 35 extend from the lower end portion of the front surface 30a to the upper end portion of the back surface 30b through the lower end surface of the second housing 30.

The second housing 30 accommodates a first sensor 41, a second sensor 42, a third sensor 43, and a fourth sensor 44. The sensors 41 to 44 are, for example, magnetic sensors, and are located opposite the slits 35, individually. The sensors 41 to 44 may alternatively be switches or other types of sensing means.

The pair of slide hinge structures 13 each comprise a lug 51, rail 52, first stop 53, and second stop 54. The second stop 54 is an example of a stop. The pair of lugs 51 are included in the main unit 11. On the other hand, the rails 52 and first and second stops 53 and 54 are included in the display unit 12.

The lugs 51 protrude from the top surface 20a of the first housing 20 and are located on the rear end portion of the first housing 20. Each lug 51 is a plate inserted into its corresponding slit 35 of the display unit 12.

Each lug 51 comprises a pin 56, engagement portion 57, and magnet 58. The pin 56 projects perpendicular to the slits 35. The engagement portion 57 is a recess in the distal end of the lug 51. The magnet 58 has magnetic force detectable by the first to fourth sensors 41 to 44.

Each rail 52 is disposed in its corresponding slit 35 of the display unit 12. The pin 56 of the lug 51 is fitted in rail 52. Thus, the display unit 12 is slidable relative to the main unit 11. As shown in FIG. 8, moreover, the display unit 12 is pivotable relative to the main unit 11 when the pin 56 is located at the lower end portion of the rail 52.

The first and second stops 53 and 54 are disposed in each slit 35 of the display unit 12. The stops 53 and 54 are, for example, protrusions projecting from the inner surface of the slit 35 and elastically engage the engagement portion 57 of the lug 51. The first stop 53 is located side by side with the first sensor 41. The second stop 54 is located side by side with the second sensor 42.

Communication between the main unit 11 and display unit 12 is based on, for example, wireless communication. Alternatively, however, it may be performed using, for example, a flexible printed circuit board or other conducting member.

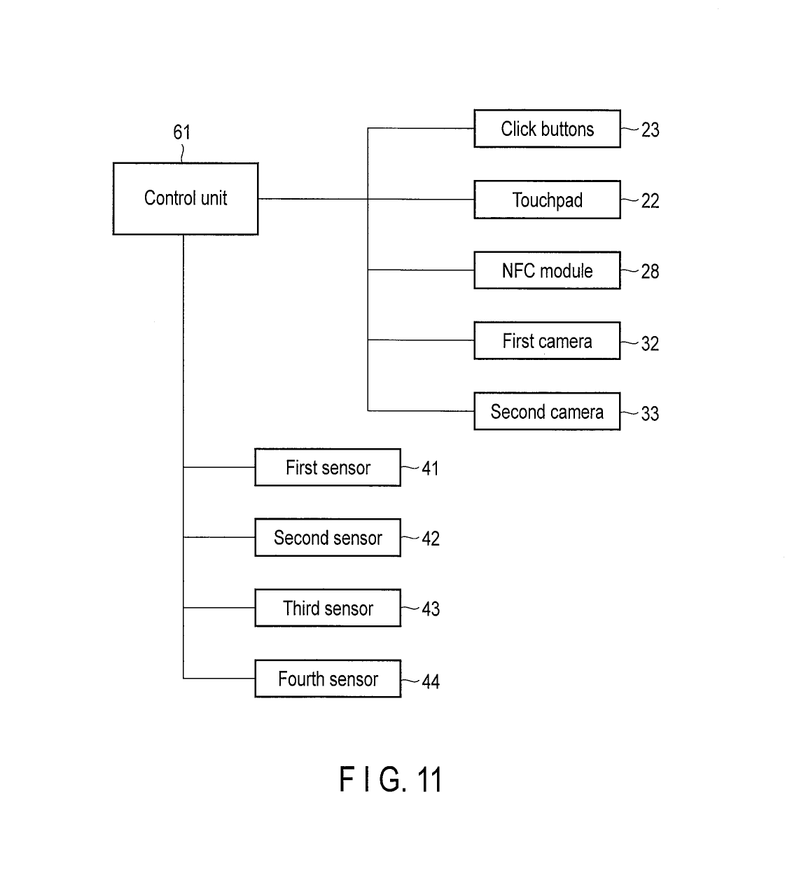

FIG. 11 is an exemplary diagram schematically showing a configuration of the portable computer 10. As shown in FIG. 11, the portable computer 10 comprises a control unit 61. The control unit 61 comprises various components, such as the motherboard, HDD, and memory accommodated in the first housing 20.

The control unit 61 is connected to the keyboard 21, touchpad 22, click buttons 23, NFC module 28, first and second cameras 32 and 33, and first to fourth sensors 41 to 44. The control unit 61 serves to perform communication between these components, stop the functions of the components, and start the components.

FIG. 12 is an exemplary flowchart showing an example of a control method for the portable computer 10 performed when the display unit 12 moves from the first position to the fourth position. The control of the portable computer 10 during this movement of the display unit 12 will be described with reference to FIGS. 1 to 12.

The portable computer 10 with the display unit 12 in the first position, as shown in FIG. 1, is used as an apparatus called, for example, a tablet or slate computer. The user holds the portable computer 10 during operation.

As shown in FIG. 2, the display unit 12 in the first position covers the top surface 20a of the first housing 20 of the main unit 11. Thus, the keyboard 21 and the palmrest 27, which comprises the touchpad 22, click buttons 23, and communication area 29, are covered by the display unit 12. Further, the second camera 33 attached to the display unit 12 is covered by the main unit 11.

If the display unit 12 is moved to the first position, the first stops 53 elastically engage the engagement portions 57 of their corresponding lugs 51. Thus, the display unit 12 is locked to the first position by the first stops 53.

The magnet 58 of each lug 51 faces the first sensor 41. The first sensor 41 detects the magnetism of the magnet 58 and transmits a signal to the control unit 61. On receiving the signal from the first sensor 41, the control unit 61 determines that the display unit 12 is in the first position.

If the first sensor 41 determines that the display unit 12 is in the first position (A1), as shown in FIG. 12, the control unit 61 disables the NFC module 28 (A2), then the touchpad 22 and click buttons 23 (A3), and moreover, the second camera 33 (A4). For example, the control unit 61 stops current supply to the NFC module 28 or disables an operating system (OS) from recognizing the NFC module 28.

The display unit 12 in the first position is slid along the rails 52 to the second position when it is pushed by the user, for example. If the display unit 12 is subjected to an external force, for example, the first stops 53 are elastically moved and easily disengaged from the engagement portions 57 of their corresponding lugs 51.

The portable computer 10 with the display unit 12 in the second position, as shown in FIG. 3, is held by, for example, the user as it is operated, as in the case where the display unit 12 is in the first position.

As shown in FIG. 4, the display unit 12 in the second position covers the keyboard 21. On the other hand, the display unit 12 allows the palmrest 27 to be exposed. Thus, the second camera 33 of the display unit 12, as well as the communication area 29, is exposed.

If the display unit 12 is moved to the second position, the second stops 54 elastically engage the engagement portions 57 of their corresponding lugs 51. Thus, the display unit 12 is locked to the second position by the second stops 54.

The magnet 58 of each lug 51 faces the second sensor 42. The second sensor 42 detects the magnetism of the magnet 58 and transmits a signal to the control unit 61. On receiving the signal from the second sensor 42, the control unit 61 determines that the display unit 12 is in the second position.

If the second sensor 42 determines that the display unit 12 is in the second position (A5), as shown in FIG. 12, the control unit 61 enables the NFC module 28 (A6), disables the touchpad 22 and click buttons 23 (A7), and moreover, enables the second camera 33 (A8). For example, the control unit 61 supplies current to the NFC module 28 or enables the operating system (OS) to recognize the NFC module 28.

When the NFC module 28 is enabled, it performs wireless communication under the control of, for example, an application. If a smartcard 62 is waved above the communication area 29, the NFC module 28 performs wireless communication with the smartcard 62 outside the communication area 29. For example, the NFC module 28 reads data recorded on an IC chip in the smartcard 62.

The display unit 12 in the second position is slid along the rails 52 to the third position when it is pushed by the user, for example. If the display unit 12 is subjected to an external force, for example, the second stops 54 are elastically moved and easily disengaged from the engagement portions 57 of their corresponding lugs 51.

The portable computer 10 with the display unit 12 in the third position, as shown in FIG. 5, is used as a notebook computer. The user operates the portable computer 10 on, for example, a desk.

The display unit 12 in the third position allows the keyboard 21 and the palmrest 27 comprising the communication area 29 to be exposed. Further, the second camera 33 of the display unit 12 is exposed.

As shown in FIG. 6, the magnet 58 of each lug 51 faces the third sensor 43. The third sensor 43 detects the magnetism of the magnet 58 and transmits a signal to the control unit 61. On receiving the signal from the third sensor 43, the control unit 61 determines that the display unit 12 is in the third position.

If the third sensor 43 determines that the display unit 12 is in the third position (A9), as shown in FIG. 12, the control unit 61 enables the NFC module 28 (A10), then the touchpad 22 and click buttons 23 (A11), and moreover, the second camera 33 (A12).

The display unit 12 in the third position is pivoted around the rails 52 or pins 56. Specifically, the lower end portion of the display unit 12 is pivotably coupled to the main unit 11. The pivoted display unit 12 can rise from the rear end portion of the main unit 11, as shown in FIGS. 7 and 8.

As the display unit 12 in the third position is further pivoted, it moves to the fourth position. The portable computer 10 with the display unit 12 in the fourth position, as shown in FIG. 9, is used as a closed notebook computer. The user carries the portable computer 10 in, for example, a bag.

As shown in FIG. 10, the display unit 12 in the fourth position covers the keyboard 21 and the palmrest 27 comprising the communication area 29. On the other hand, the second camera 33 of the display unit 12 is exposed. The front surface 30a of the second housing 30 of the display unit 12 faces the top surface 20a of the first housing 20 of the main unit 11.

The magnet 58 of each lug 51 faces the fourth sensor 44. The fourth sensor 44 detects the magnetism of the magnet 58 and transmits a signal to the control unit 61. On receiving the signal from the fourth sensor 44, the control unit 61 determines that the display unit 12 is in the fourth position.

If the fourth sensor 44 determines that the display unit 12 is in the fourth position (A13), as shown in FIG. 12, the control unit 61 disables the NFC module 28 (A14), then the touchpad 22 and click buttons 23 (A15), and moreover, the second camera 33 (A16). Further, the control unit 61 may suspend the OS, for example.

As described above, the display unit 12 moves between the first to fourth positions by sliding or pivoting. The display unit 12 can also move in reverse order from the fourth position to the first position.

According to the portable computer 10 constructed in this manner, the NFC module 28 can be operated even in the second position where the keyboard 21 is covered. Thus, the communication area 29 can be provided in the palmrest 27 even in the portable computer 10 that can be used as a tablet computer. The larger the area of an antenna in the NFC module 28, the higher the communication performance of the NFC module 28 is. Thus, the larger the communication area 29, the higher the communication performance of the NFC module 28 is. The palmrest 27 can comprise a communication area 29 that is wide enough for the NFC module 28 to display satisfactory communication capability. Further, the communication area 29 in the palmrest 27 is exposed to facilitate waving of the smartcard 62 even when the portable computer 10 is placed on the desk. Thus, the operation of the NFC module 28 is facilitated.

In operating the portable computer 10 with the display unit 12 in the first position, moreover, wireless communication by means of the NFC module 28 can be achieved by moving the display unit 12 to the second position. Thus, the display unit 12 need not be deliberately moved to the third position, so that the NFC module 28 can be easily operated.

When the display unit 12 is in the first position, the control unit 61 disables the NFC module 28. Thus, the NFC module 28 can be prevented from being activated with the communication area 29 concealed, so that excessive energy consumption can be reduced.

When the display unit 12 is in the second position, moreover, the control unit 61 disables the touchpad 22 and click buttons 23. Thus, malfunctioning due to the touchpad 22 and click buttons 23 can be prevented. When the display unit 12 is in the second position, input operations are performed by means of the display module 31 as a touchpanel.

The palmrest 27 comprising the communication area 29 is made of a resin, a nonconductor. Thus, the palmrest 27 can be prevented from impeding the communication function of the NFC module 28. The palmrest 27 is not limited to this structure, and only the communication area 29 may be made of a nonconductor, and the other part, of a metal.

As the second stops 54 engage the engagement portions 57 of their corresponding lugs 51, the display unit 12 is locked to the second position. Thus, the display unit 12 can be prevented from moving excessively, so that the NFC module 28 can be easily operated.

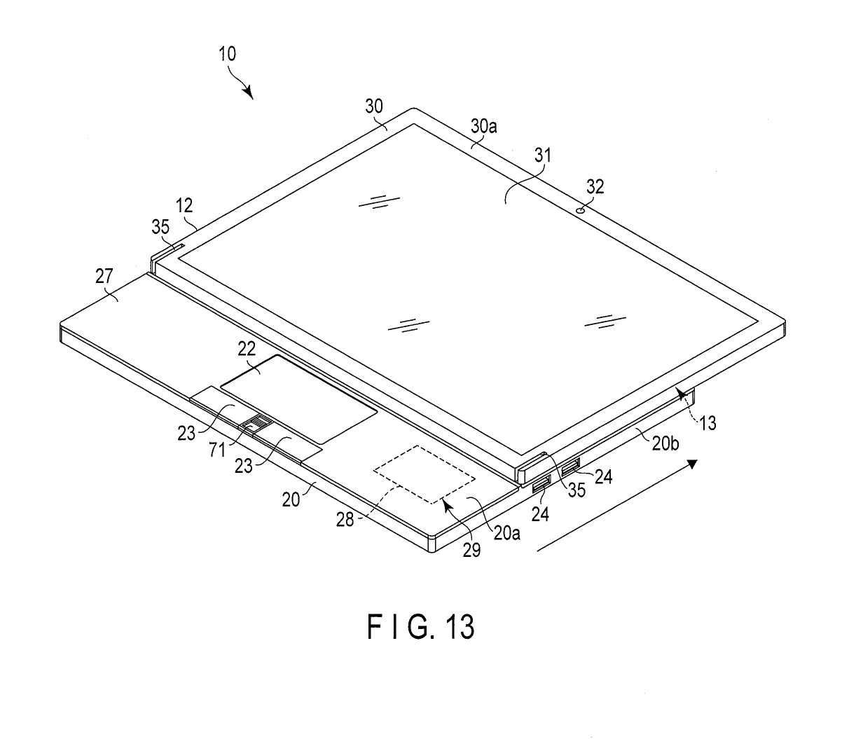

A second embodiment will now be described with reference to FIG. 13. In the description of at least one of the embodiments to follow, like reference numbers are used to designate like constituent parts having the same functions as those of the portable computer 10 of the first embodiment. Further, a description of those constituent parts may be partially or entirely omitted.

FIG. 13 is an exemplary perspective view showing a portable computer 10 according to the second embodiment. As shown in FIG. 13, the portable computer 10 of the second embodiment comprises a fingerprint authentication device 71. This device 71 is attached to the palmrest 27 and located between a pair of click buttons 23. The fingerprint authentication device 71 is used, for example, to unlock the portable computer 10.

A control unit 61 disables the fingerprint authentication device 71 when a display unit 12 is in a first or fourth position. When the display unit 12 is in a second or third position, in contrast, the control unit 61 enables the device 71.

According to the portable computer 10 of the second embodiment, the fingerprint authentication device 71 is enabled when the display unit 12 is in the second position. Even when the display unit 12 is in, for example, the first position, therefore, the device 71 can be used by moving the display unit 12 to the second position. Thus, the fingerprint authentication device 71 can be easily operated.

The component that is enabled when the display unit 12 is in the second position is not limited to the fingerprint authentication device 71 and may be one of various components, such as a button, speaker, and optical disc drive (ODD).

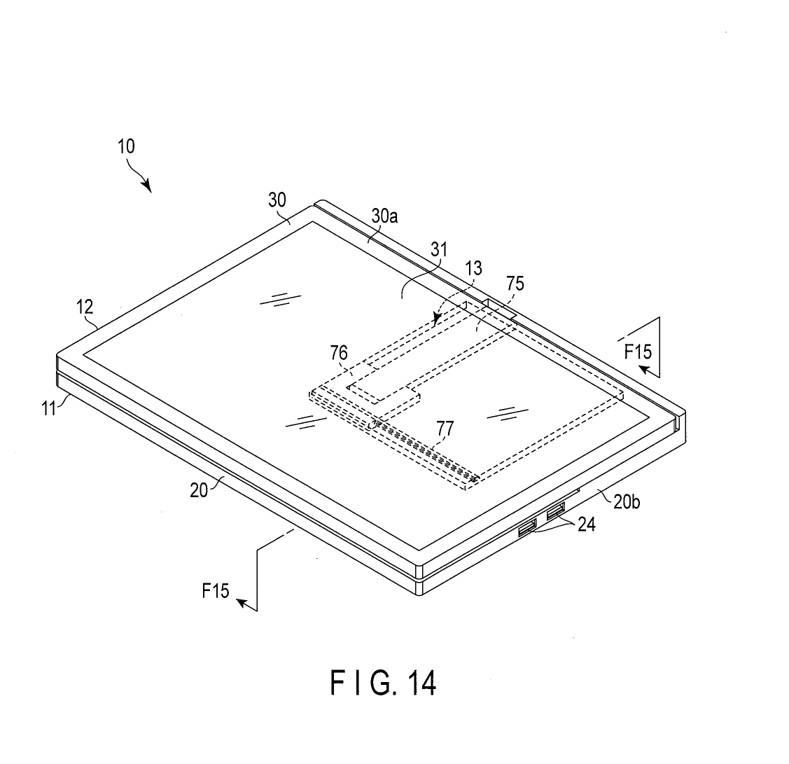

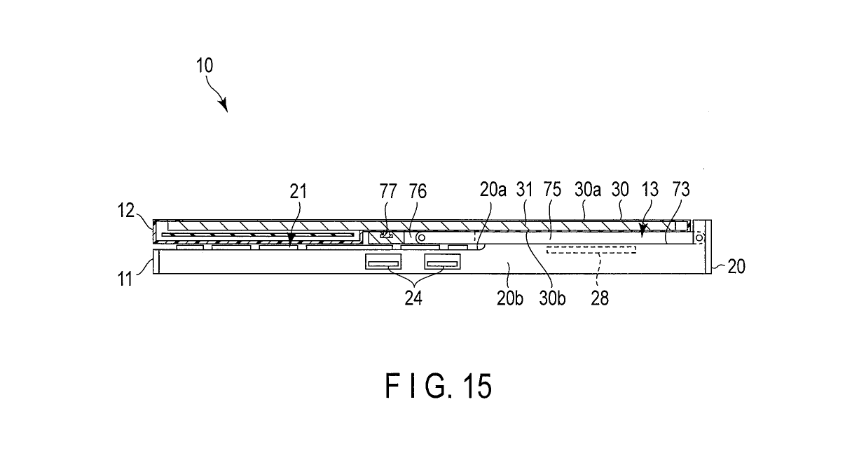

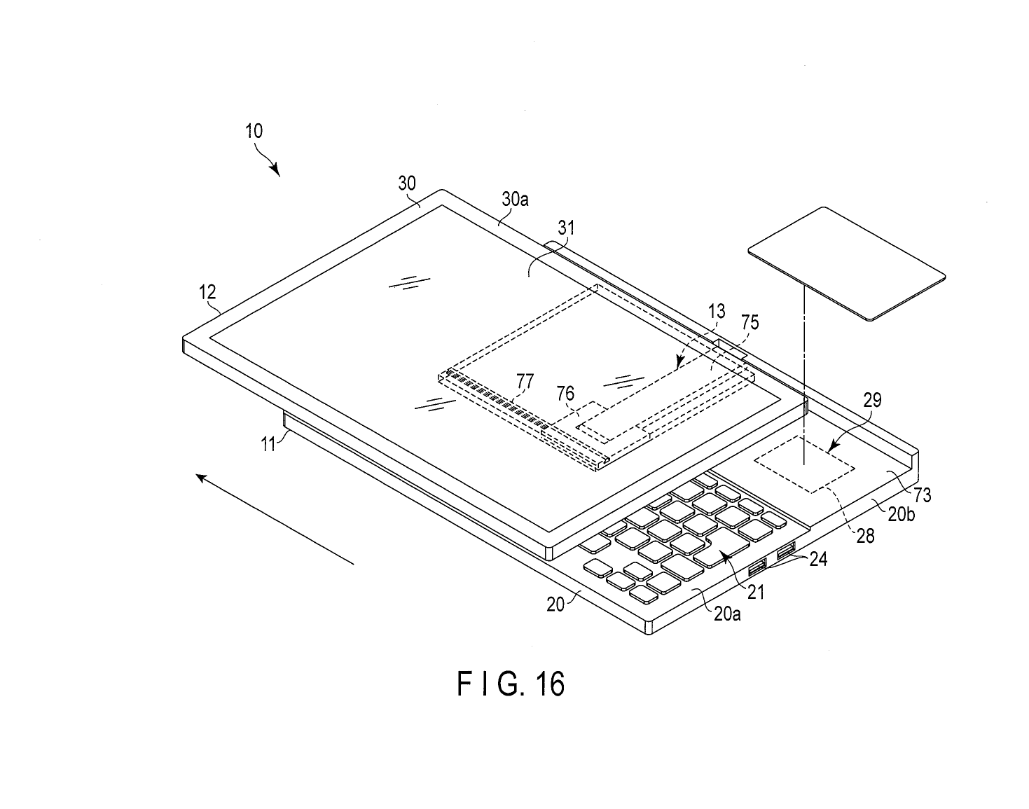

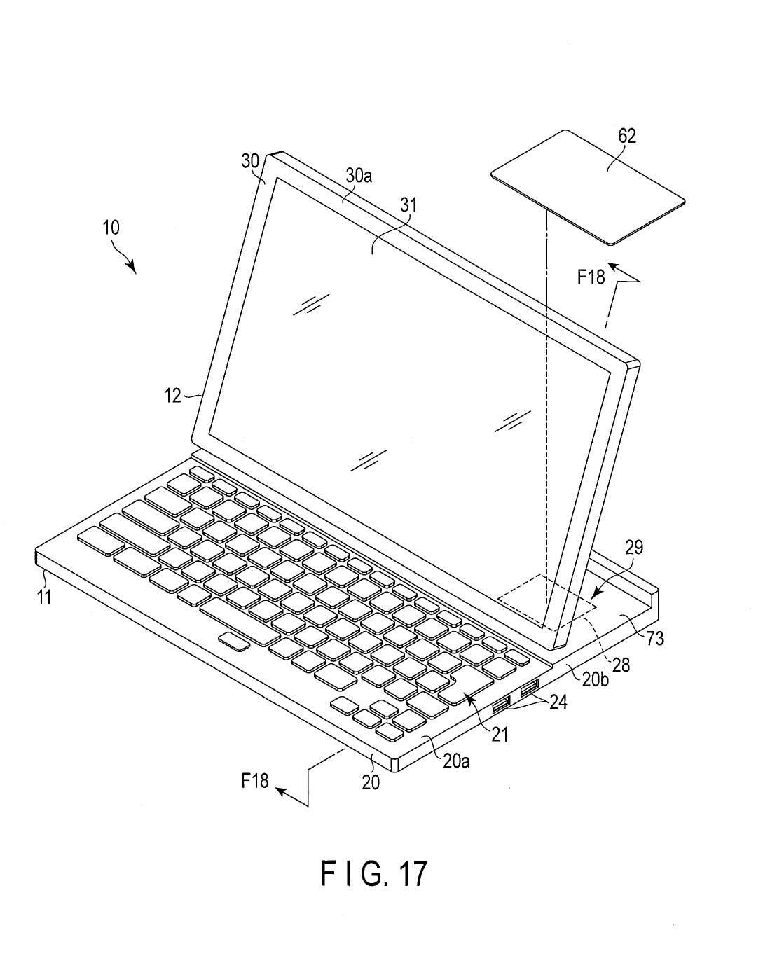

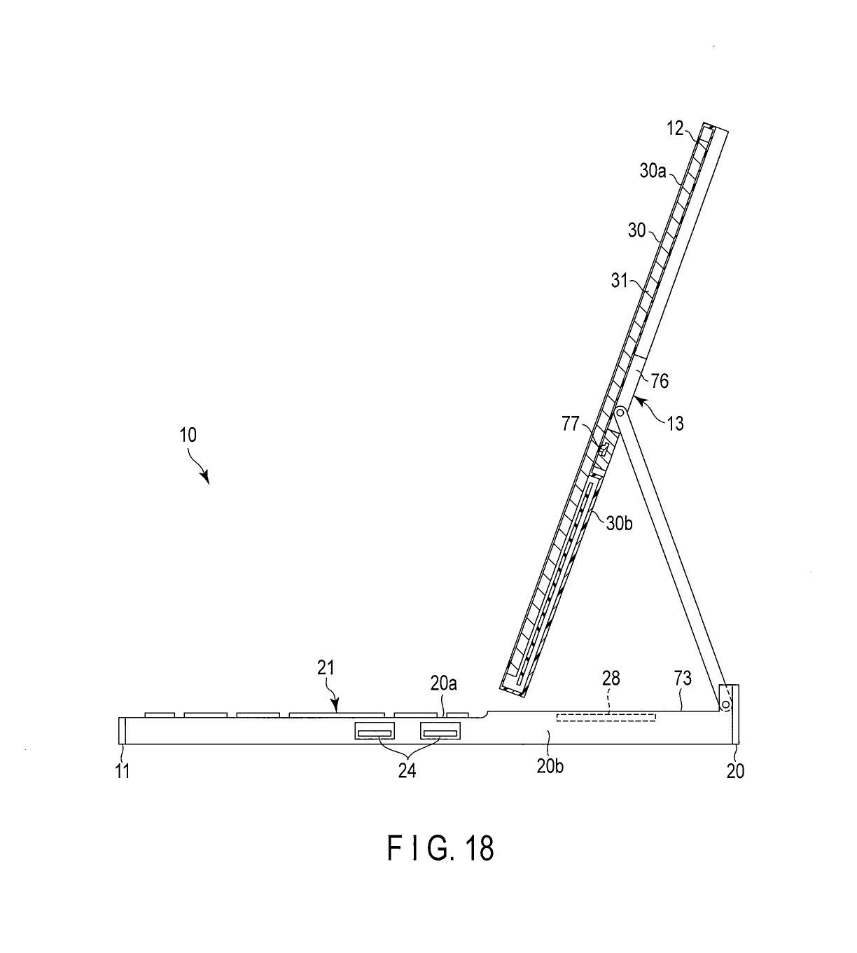

A third embodiment will now be described with reference to FIGS. 14 to 18. FIG. 14 is an exemplary perspective view showing a portable computer 10 according to the third embodiment with its display unit 12 in a first position. FIG. 15 is an exemplary sectional view of the portable computer 10 taken along line F15-F15 of FIG. 14. FIG. 16 is an exemplary perspective view of the portable computer 10 with the display unit 12 in a second position. FIG. 17 is an exemplary perspective view of the portable computer 10 with the display unit 12 in a third position. FIG. 18 is an exemplary sectional view of the portable computer 10 taken along line F18-F18 of FIG. 17.

In the third embodiment, as shown in FIG. 17, a first housing 20 of a main unit 11 comprises a flat portion 73 in place of the palmrest 27. The flat portion 73 is made of, for example, a resin and forms a part of a top surface 20a of the first housing 20. The flat portion 73 is located behind a keyboard 21. A communication area 29 is disposed in the flat portion 73.

As shown in FIG. 15, a slide hinge structure 13 comprises an arm 75, slide portion 76, and rail 77. One end portion of the arm 75 is pivotably coupled to the rear end portion of the main unit 11. The slide portion 76 is pivotably coupled to the other end portion of the arm 75.

The rail 77 is secured to a back surface 30b of a second housing 30 of the display unit 12. The rail 77 extends longitudinally relative to the display unit 12. In other words, the rail 77 extends from side to side.

The slide portion 76 is movably attached to the rail 77. Specifically, the rail 77 is slidably fitted in a groove in the slide portion 76. Thus, the display unit 12 can slide relative to the main unit 11 along the rail 77.

As shown in FIGS. 14 and 15, the display unit 12 in the first position covers the keyboard 21 and flat portion 73. Thus, the communication area 29 is covered by the display unit 12.

When the display unit 12 is in the first position, a control unit 61 disables an NFC module 28 and the keyboard 21. The control unit 61 controls, for example, various sensors to detect that the display unit 12 is in the first position.

The display unit 12 in the first position is slid along the rail 77 to the second position when it is pushed by the user, for example.

As shown in FIG. 16, the display unit 12 in the second position covers a part of the keyboard 21. On the other hand, the display unit 12 allows the communication area 29 in the flat portion 73.

When the display unit 12 is in the second position, the control unit 61 enables the NFC module 28 and disables the keyboard 21.

If the user pivots the display unit 12 and arm 75, the display unit 12 moves to the third position. The display unit 12 may be moved from the first position to the third position or from the second position to the third position.

As shown in FIG. 17, the display unit 12 in the third position allows the keyboard 21 and the communication area 29 in the flat portion 73 to be exposed. When the display unit 12 is in the third position, the control unit 61 enables the NFC module 28 and keyboard 21.

As described above, the display unit 12 is coupled to the main unit 11 for movement between the first to third positions. Thus, according to the portable computer 10 of the third embodiment, the NFC module 28, like that of the first embodiment, can be easily operated.

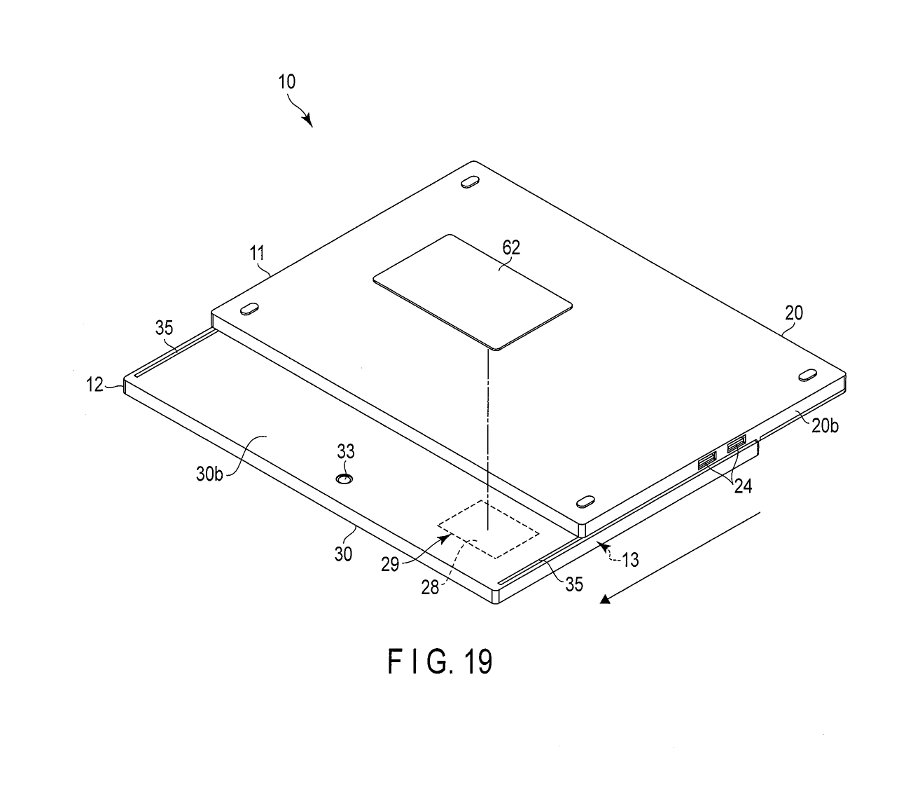

A fourth embodiment will now be described with reference to FIG. 19. FIG. 19 is a perspective view showing a portable computer 10 according to the fourth embodiment with its display unit 12 in a second position.

As shown in FIG. 19, a NFC module 28 according to the fourth embodiment is disposed in the display unit 12. A communication area 29 is disposed in a back surface 30b of a second housing 30 of the display unit 12. The second housing 30 is made of a nonconductor, such as a resin.

The communication area 29 is exposed when the display unit 12 is in any of second to fourth positions. When the display unit 12 is in a first position, in contrast, the communication area 29 is covered by a main unit 11.

The control unit 61 enables the NFC module 28 when the display unit 12 is in the second or third position. When the display unit 12 is in the first or fourth position, in contrast, the control unit 61 disables the NFC module 28.

The display unit 12 of the fourth embodiment, like that of the first embodiment, is coupled to the main unit 11 for movement between the first to fourth positions. Thus, according to the portable computer 10 of the fourth embodiment, the NFC module 28, like that of the first embodiment, can be easily operated.

According to at least one of the electronic apparatuses described herein, the second section comprises the display unit for image display and is movable between the first position where it covers the input unit and communication area, the second position where it covers at least a part of the input unit and allows the communication area to be exposed, and the third position where it allows the input unit and communication area to be exposed. Thus, the wireless communication module can be easily operated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first section comprising a first surface which comprises an input unit and a communication area;
a wireless communication module in the first section configured to perform wireless communication with the outside of the communication area; and
a second section comprising a display unit configured to display an image, coupled to the first section, and configured to move between a first position where the second section is configured to cover the input unit and the communication area, a second position where the second section is configured to cover at least a part of the input unit and to allow the communication area to be exposed, and a third position where the second section is configured to allow the input unit and the communication area to be exposed.

2. The electronic apparatus of claim 1, wherein the display unit comprises a touchpanel, and the second section comprises a second surface which comprises the display unit, and a third surface located opposite the second surface and configured to face the first surface of the first section when in the first position.

3. The electronic apparatus of claim 2, wherein the first surface comprises a palmrest which comprises the communication area, and the input unit comprises a keyboard.

4. The electronic apparatus of claim 3, wherein the second section is configured to slide between the first and second positions and between the second and third positions, and an end portion of the second section is configured to pivot in the third position.

5. The electronic apparatus of claim 4, further comprising:
a control unit configured to disable the wireless communication module when the second section is in the first position and to enable the wireless communication module when the second section is in the second or third position; and
a touchpad on the first surface of the first section,
wherein the second section is configured to cover the touchpad when in the first position and to allow the touchpad to be exposed when in the second or third position, and
the control unit is configured to disable the touchpad when the second section is in the first or second position and to enable the touchpad when the second section is in the third position.

6. The electronic apparatus of claim 5, wherein a part of the palmrest comprising the communication area is made of a nonconductor.

7. The electronic apparatus of claim 6, further comprising a stop configured to lock the second section to the second position.

8. The electronic apparatus of claim 7, further comprising a camera on the third surface of the second section, wherein the first section is configured to cover the camera when in the first position and to allow the camera to be exposed when in the second or third position.

9. A control method for an electronic apparatus, which comprises a first section comprising a first surface which comprises an input unit and a communication area, a wireless communication module in the first section configured to perform wireless communication with the outside of the communication area, and a second section comprising a display unit configured to display an image, coupled to the first section, and configured to move between a first position where the second section is configured to cover the input unit and the communication area, a second position where the second section is configured to cover at least a part of the input unit and to allow the communication area to be exposed, and a third position where the second section is configured to allow the input unit and the communication area to be exposed, the control method comprising:
disabling the wireless communication module when the second section is in the first position, and
enabling the wireless communication module when the second section is in the second or third position.

10. An electronic apparatus comprising:
a first section comprising a first surface which comprises an input unit;
a second section comprising a second surface, which comprises a display unit configured to display an image, and a third surface, which is located opposite the second surface and comprises a communication area, the second section being coupled to the first section and configured to move between a first position where the second section is configured to cover the input unit and the first section is configured to cover the communication area, a second position where the second section is configured to cover at least a part of the input unit and to allow the communication area to be exposed, and a third position where the second section is configured to allow the input unit and the communication area to be exposed; and
a wireless communication module in the second section configured to perform wireless communication with the outside of the communication area.
